(19) United States
(12) Patent Application Publication
(10) Pub. No.: US 2014/0266553 A1
(43) Pub. Date: Sep. 18, 2014

(54) BOBBIN AND MAGNETIC MECHANISM USING THE SAME

(71) Applicant: DELTA ELECTRONICS, INC., Taoyuan Hsien (TW)

(72) Inventors: Chia-Hung CHEN, Taoyuan Hsien (TW); Zhi-Liang ZHANG, Taoyuan Hsien (TW)

(73) Assignee: DELTA ELECTRONICS, INC., Taoyuan Hsien (TW)

(21) Appl. No.: 14/096,463

(22) Filed: Dec. 4, 2013

(30) Foreign Application Priority Data
Mar. 14, 2013 (TW) 102118952

(51) Int. Cl. H01F 27/00; B65H 75/18

(52) U.S. Cl. CPC H01F 27/006; B65H 75/185
USPC 336/208; 242/118

(57) ABSTRACT

A magnetic mechanism is disclosed, which includes a bobbing, a first and a second magnetic core and a winding coil. The bobbing includes a main body and a base member. The first and second magnetic cores are disposed on two opposite sides of the main body, and the winding coil is wound on a wire-winding portion of the main body and is threaded through a guiding hole of the base, wherein the guiding hole is away from the wire-winding portion in comparison with the outer most edge of the main body.

### CROSS REFERENCE TO RELATED APPLICATIONS

This application claims priority of Taiwan Patent Application No. 102108952, filed on Mar. 14, 2013, the entirety of the above-mentioned patent applications is incorporated by reference herein.

### BACKGROUND OF THE INVENTION

1. Field of the Invention

The invention relates to a bobbin and a magnetic mechanism using the same bobbin, and more particularly, to a bobbin with an increased safety distance so as to meet safety regulations and to a magnetic mechanism using the bobbin.

2. Description of the Related Art

Magnetic mechanisms have been widely applied in a variety of electric appliances as a basic circuit component for the operation of an electronic device. Nowadays, electronic devices are being developed to have small sizes, high power requirements, and diversified functions. As such, the magnetic mechanisms need to be slim, have diversified appearances, have enhanced performances and be cost-effective.

Generally, magnetic mechanisms, such as a transformer, include a primary winding coil, and a secondary winding coil. The primary winding coil and the secondary winding coil are wound up and down in a bobbin. Due to safety concerns, a plurality of first end portions of the first winding coil and a plurality of second end portions of the second winding coil are respectively hung on first pins and second pins that are respectively disposed on two opposite sides of the bobbin, such that a safety distance is maintained. Then, the bobbin wound with the primary winding coil and the secondary winding coil is connected to magnetic cores to construct the magnetic mechanism.

Accordingly, it is desirable to provide a magnetic mechanism having a safety distance between two opposite sides thereof in order to meet strict safety regulations, such as safety standards, established by the Standardization Administration of the People's Republic of China, for an electrical device applied at altitudes exceeding 5000 m above sea level.

### BRIEF SUMMARY OF THE INVENTION

The main objective of the disclosure is to provide a magnetic mechanism and a bobbin thereof. Through a base member that is projected outwardly from a main body of the bobbin, a safety distance of the magnetic mechanism is increased without changing the original structure of the main body of the bobbin.

An exemplary embodiment of the disclosure provides a magnetic mechanism including a bobbin, two magnetic cores, and at least one winding coil. The bobbin includes a main body and a base member detachably connected to the main body. The main body includes a wire-winding portion, a block board, and a mounting portion. The wire-winding portion has a passage, and the block board is disposed at one end of the wire-winding portion. The mounting portion extends from an outer edge of the block board in a direction away from the wire-winding portion and terminates at an end portion, wherein the end portion of the mounting portion and the wire-winding portion are spaced apart by a first distance. The base member includes a positioning portion and a guiding portion. The base member is connected to the main body via the positioning portion. The guiding portion has a guiding hole, wherein the guiding hole and the wire-winding portion are spaced apart by a second distance, and the second distance is larger than the first distance. The two magnetic cores are respectively connected to two opposite ends of the bobbin, and the winding coil is wound around the wire-winding portion and led through the guiding hole.

In some embodiments, the mounting portion includes a positioning groove and a pin, and the positioning portion includes a first positioning structure and a second positioning structure, wherein the first positioning structure is disposed in the positioning groove, and the pin is inserted into the second positioning structure.

In some embodiments, the main body further includes a flange extending from the mounting portion and toward a bottom side of the bobbin, and the positioning portion includes a third positioning structure, wherein the third positioning structure abuts the flange.

In some embodiments, the base member includes a block protruding from a bottom surface of the guiding portion, and the main body includes a supporting structure protruding from the flange, wherein the supporting structure and the block are positioned along the same reference plane.

In some embodiments, the guiding portion is projected from a substantially centered portion of the mounting portion, whereby unoccupied spaces are formed at the two opposite sides of the guiding portion.

In some embodiments, an extending direction of the passage is parallel to an extending direction of the guiding hole.

In some embodiments, the base member is detachably connected to the main body.

In some embodiments, the main body further includes second mounting portions. The second mounting portion is disposed at a side of the block board opposite to a side where the first mounting portion is disposed. A first pin is projected from the first mounting portion, and a second pin is projected from the second mounting portion, and a length of the first pin is smaller than a length of the second pin.

In some embodiments, the base member is connected to the main body in a vicinity of the first end of the main body, and the winding coil is led out the wring portion in a vicinity of the second end of the main body and is threaded through the guiding hole.

By the arrangement where the guiding hole and the wire-winding region are spaced with a distance that is larger than a distance between the outer edge of the main body and the wire-winding region, a safety distance of the magnetic mechanism is increased to meet the safety standards.

### BRIEF DESCRIPTION OF THE DRAWINGS

The invention can be more fully understood by reading the subsequent detailed description and examples with references made to the accompanying drawings, wherein:

FIG. 1 shows an explosive view of a bobbin in accordance with some embodiments of the disclosure;

FIG. 2 shows a top view of a main body of the bobbin in accordance with some embodiments of the disclosure;

FIG. 3 shows a schematic perspective view of a base member of the bobbin in accordance with some embodiments of the disclosure;

FIG. 4 shows a bottom view of the bobbin in accordance with some embodiments of the disclosure;

FIG. 5 shows a schematic view of a magnetic mechanism in accordance with some embodiments of the disclosure;

FIG. 6 shows an explosive view of a bobbin in accordance with some embodiments of the disclosure; and

FIG. 7 shows a bottom view of the bobbin in accordance with some other embodiments of the disclosure.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Referring to FIG. 1, the bobbin 10 in accordance with some embodiments of the disclosure includes a main body 100 and a base member 200. The base member 200 is moveably connected to the main body 100 to increase a safety distance of a magnetic mechanism (not shown in FIG. 1) using the bobbin 10.

The structural features of the main body 100 and the base member 200 are described in detail hereinafter. The main body 100 includes a wire-winding portion 110, two block boards 120 and 130, a first mounting portion 140, a second mounting portion 150, two flanges 160 and a plurality of supporting structures 165. The two block boards 120 and 130 are disposed at the two opposite sides of the wire-winding portion 110, wherein a passage 115 penetrates through the wire-winding portion 110 and the two block boards 120 and 130. From two opposite outer edges of the block board 120, the first and second mounting portions 140 and 150 are respectively extend in a direction which is away from the wire-winding portion 110 and terminate at the end portions 140a and 150a, wherein the end portion 140a of the first mounting portion 140 and an outer surface 110a of the wire-winding portion 110 are spaced apart by a first distance d1.

Referring to FIG. 2, the first mounting portion 140 includes a plurality of holding slots 141 and a positioning groove 143, and the second mounting portion 150 includes a plurality of holding slots 151 and a positioning groove 153. The holding slots 141 and 151 are configured to be wound by winding coils (not shown in FIG. 2), and in the vicinity of the holding slots 141 and 151, a plurality of reference points 145 and 155 are positioned along the bottom surfaces of the first and second mounting portions 140 and 150. In the embodiment, two pins 147 are projected from the reference points 145 positioned at the first mounting portion 140, and six pins 157 are projected from the reference points 155 positioned at the second mounting portion 150. It is noted that, as shown in FIG. 1, a length of each of the pins 147 is smaller than a length of each of the pins 157. In addition, the positioning grooves 143 and 153 are respectively formed at a substantially centered portion of the first and second mounting portions 140 and 150, as shown in FIG. 2.

The flanges 160 respectively extend from the first and second mounting portions 140 and 150 and away from the block board 120. From the top view shown in FIG. 2, each of the flanges 160 has a substantially V-shaped profile, and the flanges 160 on the first mounting portions 140 align with the positioning groove 143. Specifically, the flange 160 includes a first segment 161 and two second segments 163. The first segment 161 includes a recessed portion 161a and two stop portions 161b, wherein the recessed portions 161a faces the positioning groove 143, and the two stop portions 161b are positioned at the two sides of the recessed portions 161a and extend in a direction away from the recessed portions 161a. The two second segments 163 of the flange 160 are respectively connected to two sides of the first segment 161, wherein the supporting structures 165 are disposed on a side of each of the two second segments 163 which are away from the first segment 161.

Referring to FIG. 3, the base member 200 includes a positioning portion 210, a guiding portion 260, and two blocks 263. The positioning portion 210 includes a first positioning structure 220, two second positioning structures 230, a third positioning structure 240, and a fourth positioning structure 250. The first positioning structure 220 is an embossment and has a profile that is compatible with that of the positioning grooves 143. In the embodiment, the first positioning structure 220 has a rectangular shaped form. The two second positioning structures 230 are two insertion holes which correspond to the two pins 147. The third positioning structure 240 includes an outer edge 241, and the outer edge 241 has a profile that is compatible with that of the flange 160. The fourth positioning structure 250 is perpendicular with the third positioning structure 240 and connected to the guiding portion 260. The guiding portion 260 includes two guiding holes 261 and two blocks 263 (only one block 263 is shown in FIG. 3). The two guiding holes 261 respectively penetrate a first surface 260a and a second surface 260b opposite to the first surface 260a of the guiding portion 260. The two blocks 263 are respectively positioned at the two corners of the second surface 260b and are adjacent to the two guiding holes 261.

Referring to FIG. 1 again and with reference to FIGS. 2-4, to assemble the bobbin 10, the base member 200 is connected to the main body 100 via the positioning portion 210. Specifically, the first positioning structure 220 is disposed in the positioning groove 143 (FIG. 2), so as to limit the movement of the base member 200 in a Z direction; the two pins 147 are inserted into the two second positioning structures 230, so as to limit the movement of the base 200 in a Y direction and in the Z direction. The outer edge 241 of the third positioning structure 240 abuts the flange 160 (FIG. 4) so as to limit the movement of the base member 200 in the direction Y. The fourth positioning structure 250 abuts the end portion 140a of the first mounting portion 140 so as to limit the movement of the base 200 in the Y and Z directions.

As shown in FIG. 4, when the base member 200 is connected to the main body 100, the guiding portion 260 is projected outwardly from a substantially centered portion of the first mounting portion 140. Therefore, the guiding hole 261 and the outer surface 110a of the wire-winding portion 110 are spaced apart by a second distance d2, wherein the second distance d2 is larger than the first distance d1. In addition, two unoccupied spaces A are formed at the two lateral sides of the guiding portion 260, thereby leaving extra space for accommodation of the other mechanisms next to the bobbin 10.

Moreover, as shown in FIG. 5, when base member 200 is connected to the main body 100, the supporting structure 165 of the main body 100 and the block 263 of the base member 200 are positioned along the same reference plane R, whereby the movement of the base member in an X direction is further limited. In some exemplary embodiments, the reference plane R is a surface of a circuit board, and the pins 157 are electrically connected to the circuit board.

Referring to FIG. 5, a magnetic mechanism 1 in accordance with some embodiments of the disclosure includes the bobbin 10, a winding coil 30, a first magnetic core 40, and a second magnetic core 50. The first magnetic core 40 is connected to a first end 100a of the main body 100, and the second magnetic core 50 is connected to a second end 100b of the main body 100. The winding coil 30 is wound around at the outer surface of the wire-winding portion 110 and guided to the outside of the wire-winding portion 110 from a vicinity of the second end 100b of the main body 100, wherein a fly line 31 of the winding coil 30 is threaded through the guiding hole 261.

In conclusion, the disclosed magnetic mechanism 1 has at least, the advantages as follows.

(1) The increased safety distance of the secondary side of the magnetic mechanism 1 ensures that the magnetic mechanism 1 will meet safety standards. In one exemplary embodiment, the safe distance of the secondary side is increased from 3.7 mm to 8.0 mm.

(2) The fly line 31 can be extended downwardly in a substantially vertical direction by the guiding hole 26, whereby the assembly process of the magnetic mechanism 1 is optimized, and assembly efficiency is improved.

(3) When the magnetic mechanism 1 is mounted on a circuit board (not shown in figures), the stability of the magnetic mechanism 1 is enhanced by the base member 200 and prohibited from swaying.

(4) When the magnetic mechanism 1 is mounted on a circuit board (not shown in the figures), two unoccupied spaces A are formed at the two opposite sides of the guiding portion 260, so as to accommodate the other electronic mechanisms of the circuit board, thereby promoting efficient use of space.

Referring to FIG. 6, a bobbing 60 in accordance with some embodiments of the disclosure includes a main body 300 and a base member 400. The structural feature of the main body 300 and the base member 400 are described in detail hereinafter. The main body 300 includes a wire-winding portion 310, two block boards 320 and 330, a first mounting portion 340, and a second mounting portion 350. The two block boards 320 and 330 are disposed at the two opposite sides of the wire-winding portion 310, wherein a passage 351 penetrates through the wire-winding portion 310 and the two block boards 320 and 330. The first mounting portion 340 extends from an outer edge of the block board 320 in a direction away from the wire-winding portion and terminates at an end portion 340a wherein the first mounting portion 340 includes two positioning grooves 341 (FIG. 7) at the end portion 340a, and the end portion 340a of the first mounting portion 340 and an outer surface 210a of the wire-winding portion 310 are spaced apart by a first distance d3. Corresponding to the first mounting portion 340, the second mounting portion 350 extends from an outer edge of the block board 330 in a direction away from the wire-winding portion 310 and terminates at an end portion 350a.

The base member 400 includes a positioning portion 410 and a guiding portion 440. The positioning portion 410 includes a first positioning structure 420 and a second positioning structure 430. The first positioning structure 420 includes two embossments that have profiles compatible with the two positioning grooves 341. The second positioning structure 430 is perpendicular with the first positioning structure 420 and connected to the guiding portion 440. The guiding portion 440 includes two guiding holes 441. The two guiding holes 441 respectively penetrate two opposite surfaces of the guiding portion 440.

Referring to FIG. 7 and with reference of FIG. 6, to assemble the bobbin 60, the base member 400 is connected to the main body 300 via the positioning portion 410. Specifically, the first positioning structure 420 of the base member 400 is disposed in the two positioning grooves 341 so as to limit the movement of the base member 400 in a Z direction, and the second positioning structure 430 abuts the end portion 340a of the first mounting portion 340 so as to limit the movement of the base 400 in a Y direction. In addition, the bottom surface 421 (FIG. 6) of the first positioning structure 420 abuts the second mounting portion 350 so as to limit the movement of the base 400 in an X direction.

As shown in FIG. 7, when the base member 400 is connected to the main body 300, the guiding portion 440 is projected outwardly from a substantially centered portion of the first mounting portion 340. Therefore, the guiding hole 441 and the outer surface 310a of the wire-winding portion 310 are spaced apart by a second distance d4, wherein the second distance d4 is larger than the first distance d3. In addition, two unoccupied spaces B are formed at the two opposite sides of the guiding portion 440 to leave extra room for accommodation of the other mechanisms next to the bobbin 60.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A bobbin, comprising:
a main body comprising:
a wire-winding portion having a passage;
a block board disposed at one end of the wire-winding portion, wherein the passage penetrates through the wire-winding portion and the block board; and
a first mounting portion extending from an outer edge of the block board in a direction away from the wire-winding portion and terminating at an end portion, wherein the end portion of the first mounting portion and the wire-winding portion are spaced apart by a first distance; and
a base member comprising:
a positioning portion, wherein the base member is connected to the main body via the positioning portion; and
a guiding portion connected to the positioning portion and having a guiding hole, wherein the guiding hole and the wire-winding portion are spaced apart by a second distance, and the second distance is larger than the first distance.

2. The bobbin as claimed in claim 1, wherein the first mounting portion comprises a positioning groove, and the positioning portion comprises a first positioning structure disposed in the positioning groove.

3. The bobbin as claimed in claim 2, wherein the first mounting portion comprises a pin, and the positioning portion comprises a second positioning structure, wherein the pin is inserted into the second positioning structure.

4. The bobbin as claimed in claim 3, wherein the main body further comprises a flange extending from the first mounting portion and toward a bottom side of the bobbin, and the positioning portion comprises a third positioning structure, wherein third positioning structure abuts the flange.

5. The bobbin as claimed in claim 4, wherein the main body comprises a supporting structure protruding from the flange, and the base member comprises a block protruding from a bottom surface of the guiding portion, wherein the supporting structure and the block are positioned along the same reference plane.

6. The bobbin as claimed in claim 1, wherein the guiding portion is projected from a substantially centered portion of the first mounting portion, whereby unoccupied spaces are formed at the two opposite sides of the guiding portion.

7. The bobbin as claimed in claim 1, wherein the main body further comprises a second mounting portion disposed at a side of the block board opposite to a side where the first mounting portion is disposed, wherein a first pin is projected from the first mounting portion, and a second pin is projected from the second mounting portion, and a length of the first pin is smaller than a length of the second pin.

8. The bobbin as claimed in claim 1, wherein the base member is detachably connected to the main body.

9. A magnetic mechanism comprising the bobbin as claimed in claim 1 comprising:
a first magnetic core connected to a first end of the main body;
a second magnetic core connected to a second end of the main body; and
a winding coil wound around the wire-winding portion and threaded through the guiding hole.

10. The magnetic mechanism as claimed in claim 9, wherein the base member is connected to the main body in a vicinity of the first end of the main body, and the winding coil is led out the wring portion in a vicinity of the second end of the main body and is threaded through the guiding hole.
